(19) United States
(12) Patent Application Publication
(10) Pub. No.: US 2025/0041037 A1
(43) Pub. Date: Feb. 6, 2025

(54) PARTURITION SURVEILLANCE AND ALERTING SYSTEM

(71) Applicant: DELAVAL HOLDING AB, Tumba (SE)

(72) Inventors: Cecilia BÅGENVIK, Tumba (SE); Ilka KLAAS, Tumba (SE); Bohao LIAO, Tumba (SE); Praveen SWAMY, Tumba (SE)

(21) Appl. No.: 18/717,222

(22) PCT Filed: Dec. 8, 2022
(86) PCT No.: PCT/SE2022/051157

§ 371 Date: Jun. 6, 2024

(30) Foreign Application Priority Data
Dec. 8, 2021 (SE) 2151500-2

(51) Int. Cl. A61D 17/00

(52) U.S. Cl. CPC A61D 17/008

(57) ABSTRACT

A system for alerting of an anomaly detected during a parturition event prior to separation of an offspring from an animal is provided. The system includes a control model trained to detect at least one parturition stage based on input data, a camera configured to capture a stream of images of the animal and provide the stream of images to the control model via a controller, an alerting device, and the controller. The controller is configured to determine a moment in time when one of the at least one parturition stage is commenced, determine a passed time since the moment in time and compare the passed time with a time threshold length, and either trigger the alerting device when the time threshold length is exceeded or determine when the at least one parturition stage of the parturition event is discontinued.

### CROSS-REFERENCE TO RELATED APPLICATIONS

This application is the US national stage of PCT/SE2022/051157, filed Dec. 8, 2022, and designating the United States, which claims the priority of SE 2151500-2, filed Dec. 8, 2021. The entire contents of each foregoing application are incorporated herein by reference.

### BACKGROUND OF THE INVENTION

### Field of the Invention

This document discloses a system according to the attached independent claim 1.

The parturition of animals in general is a natural process which typically is performed without human assistance.

When it comes to the calving process in dairy cattle, it is a critical situation for the dairy farmers economically. Regular insemination/pregnancy/calving is a prerequisite for milk production of the dairy cattle/cow, why calving is occurring repeatedly on a dairy farm. On a farm dedicated for meat production, or for raising animals for recreational purposes (such as pets, horses, etc.), parturition is required for increasing the herd of animals.

### DESCRIPTION OF THE RELATED ART

The farmer usually monitors the animal manually during a final part of a pregnancy period, ready to intervene, as a failure to assist the cow in case of a complication during the calving may cause severe illness of both the cow and the calf. However, most often no particular assistance is required.

To manually monitor every parturition/calving of a farm is time consuming and most often unnecessary, i.e., the farmer is not required to intervene at all. The parturition/calving may occur at an inconvenient time when the farmer is busy with other matters, for example during milking or at two a clock in the morning.

As the working time of the farmer is a scarce resource, it would be desired to be able to distinguish between a normal parturition (which could be handled by the animal herself, without any assistance at all from the farmer), and a complicated parturition, for which manual assistance is required.

### SUMMARY OF THE INVENTION

It is an object of the present invention to evolve a concept for monitoring parturition and detect when a deviation is occurring from a normal/natural parturition (for which no manual assistance is required), and then alert the farmer.

This object is achieved by a system according to claim 1, using a control model which has been appropriately trained. The inventive system aims at alerting the farmer when an anomaly is detected during a parturition event before an offspring is separated from an animal.

Thus, a system is provided, comprising a plurality of components. The system comprises for example a control model trained to detect at least one parturition stage out of a plurality of parturition stages during the parturition event, wherein said training is based on images of several parturition stages during a multitude of parturition events, such as for example some hundreds, thousands or tens of thousands of images depicting animals during parturition events. The control model is configured to repeatedly receive images via a controller, detect the parturition stage of the received image and return information concerning the detected parturition stage of the image, to the controller, which also is comprised in the system.

The system also comprises a camera configured to capture a time-sequential stream of images of the animal and provide the time-sequential stream of images to the control model, via the controller. The system comprises an alerting device, configured to output an alerting signal when receiving a trigger signal from the controller. The alerting device may for example be embodied as a mobile telephone or other similar communication device of the farmer.

The controller is communicatively connected to the control model, to the camera and the alerting device. The controller is configured to provide time-sequential stream of images, captured by the camera to the control model. The controller is also configured to determine a moment in time when a selected parturition stage of the at least one parturition stages of the parturition event is commenced, based on information returned by the control model. In addition, the controller is configured to determine, repeatedly, by a time measurement functionality, a passed time period since the determined moment in time when the selected parturition stage is commenced. The controller is configured to then compare, repeatedly, the determined passed time period since the determined moment in time when the selected parturition stage is commenced with a time threshold length associated with the selected parturition stage.

Based on the outcome of the comparison, the controller is configured to detect an anomaly of the parturition event when the time threshold length associated with the selected parturition stage is exceeded by the determined time period that has passed since the determined moment in time when the selected parturition stage is commenced. The controller is also configured to output the trigger signal to the alerting device, upon detection of the anomaly, thereby alerting the farmer concerning the detected anomaly during the parturition event.

The controller is also configured to determine when the selected parturition stage of the parturition event is completed before the time threshold length associated with the selected parturition stage has passed, based on information returned by the control model.

Thanks to the provided solution, the cognitive stress of the farmer related to parturition at the farm is relieved. The farmer is saved from the current requirements of being present and check every parturition event for anomalies and problems during the parturition. Yet he/she could rely in the system, in being alerted in case any unexpected problem or deviation occurs during the parturition and thereby be enabled to provide the required assistance to the birth giving animal.

Thereby, the working time of the farmer is reduced; time which may be used for other animal caring tasks at the farm, thereby leading to increased milk production/meat production/animal stock, depending on the type of farm, and/or increased animal comfort, which in turn leads to further increase in milk production/meat production/animal stock.

Also, as the farmer is relieved from the personal presence and inspection of every parturition event, it becomes possible to increase the number of animals at the farm and/or the repro-duction rate of animals at the farm, without increasing the working time of the farmer. Increased number of animals also leads to additionally increase in milk production/meat pro-duction/animal stock.

In embodiments of the system, the system may comprise an animal identification device configured to determine an identity reference of the animal. Also, the system may comprise a database comprising a lactation number associated with identity references of the animals.

The controller may also be configured to obtain the identity reference of the animal; to provide the identity reference of the animal to the database; to receive the lactation number of the animal from the database; and to set the time threshold length associated with the selected parturition stage of the animal, based on the received lactation number.

It has been observed by the inventor that first-time mother animals/heifers have an increased risk of having problems during the parturition, while an experienced birth giving animal typically has a smoother parturition. For this reason, the time threshold length may be set shorter for the selected parturition stage of the first-time mother animal/heifer than for the experienced mother animal/cow.

In some embodiments, the camera comprises: a video camera, stereo cameras, a three dimensional (3D) camera, and/or a thermal camera, configured to capture the time-sequential stream of images of the animal and provide the time-sequential stream of images to the control model, via the controller.

By providing the control model with images captured by different types of cameras (and previously having trained the control model with images captured by different types of cameras), the capacity of detecting different predefined features in the respective images is radically increased. For example, an amniotic sac is rather small, semi-transparent and therefore difficult to detect on e.g., a 2-dimensional Red Green Blue (RGB) image but may more easily be detected by a thermal camera as the temperature of the amniotic sac leaving the vulva will have a higher temperature than the skin of the animal.

In some embodiments, the control model may be trained to detect at least one parturition stage out of the plurality of parturition stages, wherein said training is based on measurements of a physical parameter of animals during several parturition stages during a multitude of parturition events. The control model may be configured to repeatedly receive physical parameter measurements of the animal via the controller, detect the parturition stage of the received physical parameter measurements and return information concerning the detected parturition stage of the physical parameter measurements, to the controller.

The system may in addition comprise an animal-attached sensor such as a 3D accelerometer, an inertia sensor, a gyro sensor, a heartbeat sensor and/or a thermal sensor, configured to measure a physical parameter related to the animal.

The controller may also be communicatively connected to the animal-attached sensor. Also, the controller may be configured to obtain the measured physical parameter related to the animal from the animal-attached sensor. The controller may also be configured to provide the obtained physical parameter measurements related to the animal to the control model, wherein the information returned by the control model may be based on the physical parameter measurements.

By providing the control model with measurements of a physical parameter of the animal (and previously having trained the control model with the corresponding measurements), the parturition stage could be determined with an enhanced accuracy and precision.

The selected parturition stage of the plurality of parturition stages of the parturition event may comprise detection of an amniotic sac leaving the animal in an image, in some embodiments of the system.

The selected parturition stage of the plurality of parturition stages of the parturition event may comprise detection of at least one frontal hoof and/or head of the offspring leaving the animal in an image, in some embodiments of the system.

The selected parturition stage of the plurality of parturition stages of the parturition event may comprise detection of at least 50% of the offspring leaving the animal in an image, in some embodiments of the system.

By defining a plurality of parturition stages before the offspring is successfully separated from the animal/mother and measure the duration of the selected parturition stage and compare the duration with the time threshold length of the selected parturition stage, an improved detection of an anomaly due to excessive time duration (i.e., exceeding the time threshold limit associated with the parturition stage in question) is detected during the parturition event. Optionally, the selected parturition stage of the plurality of parturition stages of the parturition event may comprise detection of a dystocia stage in an image. The controller may be configured to detect the anomaly of the parturition event when the first parturition stage comprises the dystocia stage, and output the trigger signal to the alerting device, upon detection of the anomaly.

The dystocia stage may be defined by appearance of e.g.: at least one rear hoof leaving the animal, without detection of a front part of the offspring; a back part of the offspring leaving the animal, without detection of the front part of the offspring; a head of the offspring leaving the animal, without detection of frontal hoofs; and/or body parts of more than one offspring leaving the animal.

By alerting the farmer immediately when detecting an anomaly associated with the dystocia stage, the animal could be provided with appropriate assistance immediately as the dystocia stage is detected, thereby relieving pain and suffering of the involved animal/offspring, and increasing the possibility of a successful parturition, in spite of the dystocia stage.

In yet some embodiments, the controller of the system may be configured to: determine that the parturition event of the animal has resulted in a successful parturition of the offspring; and update the lactation number associated with identity reference of the animal in the database by one.

An automatic updating of the database with the enumerated lactation number associated with the identity reference of the animal is thereby made, reducing manual administrative work of the farmer, who instead is enabled to put his/her efforts into increased animal com-forts/increased milk production/meat production.

The control model of the system may be embodied as an artificial neural network comprising an input layer, at least one hidden layer and an output layer.

Thanks to the described aspects, an alert may be triggered for alerting the farmer, in order to get him/her into performance of an appropriate action for facilitating a smooth parturition.

An advantage of the provided solution is that the animal may be monitored during parturition in a non-invasive way, not disturbing or hurting the animal/offspring.

Other advantages and additional novel features will become apparent from the subsequent detailed description.

### BRIEF DESCRIPTION OF THE DRAWINGS

### Figures

Embodiments of the invention will now be described in further detail with reference to the accompanying figures, in which:

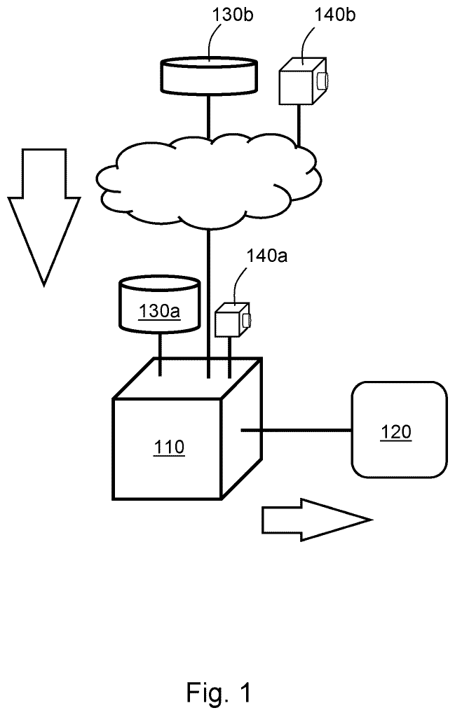

FIG. 1 illustrates an example of a processing device during training of a control model, according to an embodiment of the invention;

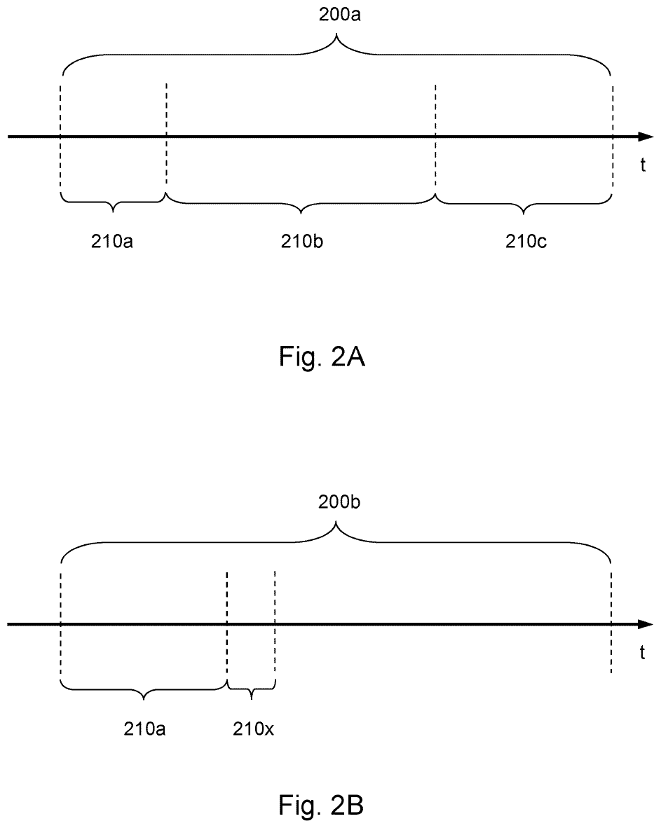

FIG. 2A illustrates an example of a parturition event, according to an embodiment of the invention;

FIG. 2B illustrates an example of a parturition event, according to an embodiment of the invention;

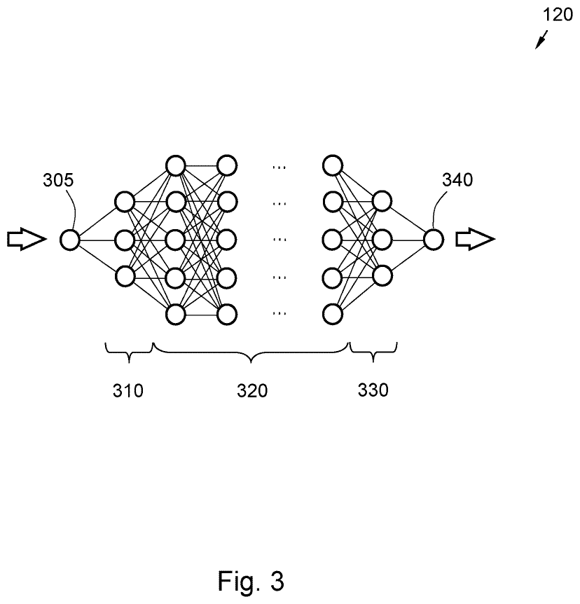

FIG. 3 illustrates an example of a neural network, according to an embodiment of the invention;

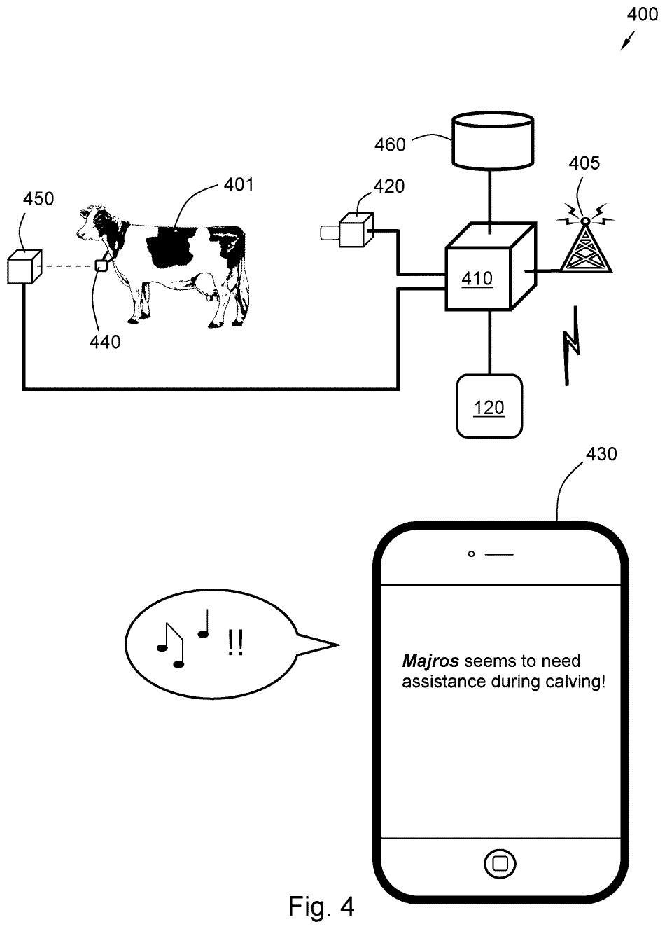

FIG. 4 is an illustration depicting a system according to an embodiment.

### DETAILED DESCRIPTION

Embodiments of the invention described herein are defined as a system, which may be put into practice in the embodiments described below. These embodiments may, however, be exemplified and realised in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and pro-cedures described herein.

FIG. 1 illustrates a schematic scenario wherein a processing device 110 for training a control model 120 to detect at least one stage of a parturition event of an animal, wherein the parturition event comprises a plurality of parturition stages before an offspring is separated from the animal. The training involves feeding of thousands of images into the control model 120, which images have been captured during a plurality of parturition events of different animals, at different moments in time.

The animal may be any arbitrary type of domesticated female mammal for example a dairy cattle/meat production animal/other animal such as e.g., cow, goat, sheep, camel, horse, dairy buffalo, donkey, yak, etc., (non-exhaustive list of animals).

In the herein discussed embodiments and drawings, the animal is exemplified with a cow which is calving.

The processing device 110 is configured to obtain a set of input data comprising a plurality of images captured e.g., during a successful non-manual assisted parturition event.

The images may be captured by a camera 140a, 140b communicatively connected, directly or indirectly with the processing device 110. The camera 140a, 140b may for example comprise one or several of a video camera, stereo cameras, a 3D camera, a thermal camera and/or similar device configured to capture one image or a sequence of images of the animal and/or offspring during the parturition.

The images may however be obtained from a local database 130a, and/or distant database 130b in some embodiments, comprising various images of animals during parturition events.

The images are depicting the animal at various parturition stages of the parturition event before an offspring is separated from an animal.

The input data during training of the control model 120 may in some embodiments comprise a plurality of animal related, physical parameter measurements captured by an animal-attached sensor such as a 3D accelerometer, an inertia sensor, a gyro sensor, a heartbeat sensor and/or a thermal sensor in addition to the images. Each parturition stage may be associated with a respective physical parameter measurement interval, which is character-istic for the parturition stage in question. Hereby, precision of successful parturition stage detection during implementation of the control model 120 is additionally improved.

The parturition event may be a successful, non-manual assisted parturition event, as schematically illustrated in FIG. 2A and further discussed in the corresponding section of the description, or an unsuccessful parturition event and/or a parturition event requiring manual assistance as schematically illustrated in FIG. 2B.

It has been observed by the inventors that the time it takes for the birth-giving animal during different stages of the parturition, is critical for determining whether the animal require manual assistance or not. For example, if a certain stage of the parturition takes longer time than a predetermined threshold time associated with that parturition stage in question, manual assistance is likely to be required due to some problem of the animal mother and/or offspring.

The parturition event is divided into a plurality of parturition stages, which are defined by appearance of one or several distinguished features. An example of a feature that may indicate a first parturition stage may be appearance of an amniotic sac leaving the animal, while a second parturition stage may be defined by appearance or presence of one or two frontal hooves of the offspring, possibly accompanied by an offspring head, or a part thereof.

A third parturition stage may be defined as appearance or presence of at least 50% of the offspring leaving the animal, i.e., the frontal hooves, the head of the offspring and at least the frontal half of the offspring.

By dividing a successful non-manual assisted parturition event of an animal into a plurality of stages during training of the control model 120, it will enable time measurement of each respective parturition stage during implementation of the control model 120 and enable a comparison with the corresponding threshold time of the parturition stage in question. It thereby becomes possible to detect a problematic parturition requiring manual assistance, with high precision.

When training the control model 120, each image is associated with a label of the parturition stage, according to presence or absence of one or several features that define the respective parturition stage. This labelling may be manually performed by a human operator, who may study the image, revising it carefully for detecting any of the features that defines the respective parturition stage.

The operator may start with inspecting an image, checking for a predefined feature out of a set of predefined features. Each of the predefined features is associated with a parturition stage, which in turn is associated with a label.

| predefined feature in image | parturition stage | label |
|---|---|---|
| a | 1 | α |
| b | 2 | β |
| c | 3 | γ |

In case the operator for example observes the predefined feature a in the studied image, the parturition is considered to be in parturition stage 1. Thus, the image comprising the feature a may be associated with the label α.

The set of labelled input data, i.e., image with the label of the respective parturition stages, is then provided to the control model 120 for training the control model 120 in determining the parturition stage of any received image of any parturition event, when applied in a system at a farm as schematically illustrated in FIG. 4.

When it comes to non-successful parturition events and/or parturition events having required manual assistance, it may be relevant to detect a dystocia stage of the parturition. Dystocia means difficult parturition/calving. When the dystocia stage is detected during implementation of the control model 120, it may be regarded as an anomaly and the farmer may be alerted immediately.

The dystocia stage may be defined as a deviation from a normal/successful parturition, such as for example detection of at least one rear hoof of the offspring leaving the animal, without detection of a front part of the offspring; detection of a back part of the offspring leaving the animal, without detection of the front part of the offspring; and/or detection of a head of the offspring leaving the animal, without detection of frontal hoofs. Detection of twin pregnancy may also be regarded as a dystocia stage, as twin parturition often requires manual assistance.

The control model 120 may be embodied as an artificial neural network as schematically illustrated in FIG. 3. The functionality of the control model 120 in different embodiments will be discussed and explained in the corresponding section of the description.

The invention is targeting detection, preferably as early as possible, of a problematic parturition that requires manual assistance of the farmer, while otherwise allowing the animal to handle the parturition herself, in case there is no particular problem during the delivery.

Thereby, the farmer is not unnecessarily disturbed by unproblematic parturition events at the farm, yet he/she is alerted when problems appear, and can thereby assist the animal when required. The farmer is relieved from manual inspection of animal deliveries at odd hours.

Thanks to the provided system, the occurrence of calving accidents among the animals at the farm is suppressed; the loss due to the death of new-born calves and the wear and suffering of the mother animals are prevented. Thus, efficiency of the breeding management at the farm is improved.

FIG. 2A schematically illustrates a parturition event 200a of an animal, wherein the offspring is successfully delivered without human assistance. The parturition event 200a may be divided into several parturition stages 210a, 210b, 210c.

In the illustrated embodiment, the parturition event 200a is divided into three distinct parturition stages 210a, 210b, 210c, besides a pre-parturition stage. This is merely a non-limiting example, the parturition event 200a may be divided into another number of parturition stages 210a, 210b, 210c in other embodiments, such as 2, 4, 5, . . . , etc. The control model 120 will be trained accordingly.

Each parturition stage 210a, 210b, 210c is defined by appearance of one or several particular features. In an example, a first parturition stage 210a may be defined by appearance or presence of an allantoic and/or amniotic sac leaving the animal. This may be regarded as a starting point of the parturition event 200a. In other embodiments, the first parturition stage 210a may be defined by appearance or opening of the cervix and the first parturition stage 210a may end with the initiation of uterine contractions, in some embodiments. At the end of this parturition stage 210a, straining bouts occur more frequently, sometimes strings of mu-cus are visible.

A second parturition stage 210b may be defined by appearance or presence of one or two frontal hooves of the offspring, possibly accompanied by an offspring head, or a part thereof.

A third parturition stage 210c may be defined as appearance or presence of at least 50% of the offspring leaving the animal, i.e., the frontal hooves, the head of the offspring and at least the frontal half of the offspring. This third parturition stage 210c may be regarded as the end of the parturition event 200a.

A pre-parturition stage may be defined by presence of the animal in the image, while no signs are seen of the amniotic sac, hooves, head or any other part of the offspring.

The described features associated with each respective parturition stage 210a, 210b, 210c may be differently defined in different embodiments. The respective feature/s defining the parturition stage 210a, 210b, 210c may also be dependent on the number of defined parturition stages 210a, 210b, 210c.

It has been noted that the time that the animal spends in each parturition stage 210a, 210b, 210c during the delivery is critical. In case the parturition remains in a certain parturition stage 210a, 210b, 210c longer than a respective threshold time limit associated with that particular parturition stage 210a, 210b, 210c, the reason may be that an anomaly has oc-curred and that the animal requires instant assistance from the farmer to succeed with the delivery.

| predefined feature | parturition stage | threshold time limit |
|---|---|---|
| a (but not b or c) | 1 | t₁ |
| b (but not c) | 2 | t₂ |
| c | 3 | t₃ |

Each parturition stage is associated with a respective threshold time limit which may be different from each other, i.e., be of different length in time.

The processing device 110 may, during the training of the control model 120, receive a set of input data comprising a plurality of images captured during successful non-manual assisted parturition events 200a. Also, the processing device 110 may receive a label of a parturition stage 210a, 210b, 210c, associated with each image, wherein the parturition stage 210a, 210b, 210c is defined based on presence or absence of one or several features in each image. The label is a manually made estimation of the appropriate parturition stage 210a, 210b, 210c, based on presence/absence of features in the image. The processing device 110 may then provide the set of labelled input data to the control model 120 for training the control model 120 in determining the parturition stage 210a, 210b, 210c of any received image of any parturition event 200a during implementation at a farm.

In some embodiments, a pre-processing of input data may be made, to adjust the number of images used for training the control model 120. It has been observed that parturition stages 210a, 210b, 210c which are defined by presence of a very small feature, i.e., smaller than a first threshold size, such as e.g., amniotic sac, will require more images for training the control model 120 than a parturition stage 210a, 210b, 210c which is defined by presence of a rather large object, i.e., having a size exceeding a second threshold size, such as 50% of the offspring.

In case more images are required, e.g., images to be labelled with the correct parturition stage 210a, 210b, 210c, augmentation of the images of that parturition stage 210a, 210b, 210c may be made by augmentation of the images. Augmentation may be made by horizon-tal flip of the image, random rotation of the image and/or shear transformation of the image, for example.

FIG. 2B schematically illustrates an unsuccessful parturition event 200b of an animal and/or a parturition event requiring manual assistance.

In the illustrated scenario, the parturition may start with a first parturition stage 210a defined by detection of an amniotic sac. However, in a dystocia stage 210x, an anomaly is detected, which indicates that the animal requires human assistance during the delivery. Some examples of features which may indicate a problematic delivery may be detection of at least one rear hoof of the offspring leaving the animal, without detection of a front part of the offspring; detection of a back part of the offspring leaving the animal, without detection of the front part of the offspring; and/or detection of a head of the offspring leaving the animal, without detection of frontal hoofs.

Detection of twin pregnancy (or multiple offspring pregnancy), detection of an unusually large offspring (i.e., larger than a reference threshold), signs of pain/unusual movements of the animal mother during parturition may also be indications of a dystocia stage for which manual assistance is required.

The selection of images may be differently made in distinct embodiments of the control model and the training thereof. For example, in some embodiments, high precision in detecting the correct parturition stage 210a, 210b, 210c, 210x may be desired in a certain agricultural environment concerning for example type of bedding (sand/hay/rubber, etc.), animal breed, wall colour, etc. It may then be an advantage to train the control model 120 with images of the same or similar agricultural environment.

In other embodiments, robustness may be desired during implementation of the control model 120. It may then be an advantage to train the control model 120 with images depicting parturition events in different agricultural environments.

FIG. 3 illustrates a control model 120 embodied as an artificial neural network comprising an input layer 310, at least one hidden layer 320 and an output layer 330.

A Convolutional Neural Network (CNN) is a class of artificial neural networks that may be applied for visual imagery applications, such as image recognition, image classification, pattern recognition, etc., such as YOLO or Deep Convolutional Network (DCN), Faster R-CNN, Single Shot Detector (SSD), etc.

Some other examples of neural networks that may be applied are Deep Feed Forward (DFF), Recurrent Neural Network (RNN), General Regression Neural Network (GRNN), Gated Recurrent Unit (GRU), Deep Belief Network (DBN); (non-exhaustive list of examples).

The control model 120/neural network is a calculating unit which comprises a plurality of mutually linked network cells, where the network cells can generate an output signal that is based on a plurality of mutually weighed input signals. The weighing factors used for weighing the input signals are adjusted by training the control model 120/neural network during a training phase.

The control model 120/neural network is provided with labelled input data such as images labelled with a label of the associated parturition stage 210a, 210b, 210c, 210x and annotated with bounding boxes across an object/feature representing that parturition stage 210a, 210b, 210c, 210x, to be detected within the image.

The weighting factors are adjusted during the training phase, in order to achieve output data corresponding to the labelled parturition stage 210a, 210b, 210c, 210x of each provided image.

| image number | label | parturition stage |
|---|---|---|
| 1 | β | 2 |
| 2 | α | 1 |
| . . . | . . . | . . . |
| 100 001 | β | 2 |

Thereafter, control data may be provided to the control model 120. The control data is different from the training data, i.e., comprises different images of parturition events. In case the output data of the control model 120 when provided with the control data corresponds with the parturition stage 210a, 210b, 210c, 210x depicted at provided image (within a predetermined margin of errors), the training of the control model 120 may be considered completed.

The control model 120 may thus be supplied with both input images and control images enabling the control model 120 to establish to what extent the parturition stage estimation calculated on the basis of the weighing factors correspond to the actual condition.

After the completed training, the control model 120 may be evaluated, for example by calculating a confidence score. The confidence score indicates the probability that a predicting bounding box contains a predefined object. Also, or alternatively, True Positive (TP), False Positive (FP) and/or False Negative (FN) may be estimated to analyse the classification accuracy for at least one parturition stage 210a, 210b, 210c, 210x. TP is the case where the Intersection Over Union (IoU) between the predicted bounding box and the ground truth bounding box for the parturition stage exceeds the IoU threshold value.

Based on these evaluation metrics, precision and/or recall may be estimated. Precision is the ability of a model to correctly identify only the relevant objects. Recall is the ability of a model to find all the relevant cases:

$$Precision = \frac{TP}{TP + FP}$$

$$Recall = \frac{TP}{TP + FN}$$

Precision indicates the fraction of detected positive samples that actually are correct. Recall indicates what proportions of actual positive samples were detected correctly. A trained control model 120 with high precision and low recall value indicates that the control model 120 has a low number of false positives and a high number of false negatives i.e., many positive samples were classified as negatives. Similarly, a trained control model 120 with high recall and low precision value indicates that the trained control model 120 has a low number of false negatives and high number of false positives i.e., many negative samples were classified as positives.

Due to the importance of both precision and recall values in evaluating the performance of the trained control model 120, a trade-off may be made between precision and recall, for example by comparing these values with a respective threshold value and approve the trained control model 120 when both the threshold values are exceeded.

The control model 120 may then, when successfully trained and approved, be provided to a farm for usage in detection of stages 210a, 210b, 210c, 210x of a parturition event 200a, 200b of an animal, based on images of the animal captured in real time, or almost real time, as illustrated in FIG. 4.

FIG. 4 illustrates a system 400 at a farm or other similar location wherein animals are raised and maintained. The system 400 aims at monitoring a pregnant animal 401 during at least the last part of the pregnancy; and alerting a farmer or other similar human when an anomaly is detected during a parturition event 200a, 200b of the animal 401 before an offspring is separated from the animal 401.

The expression “farmer” is to be understood in broad sense and may include any person related to or associated with the farm and/or the agricultural activity thereon.

The farmer may then upon receiving the alert, take appropriate measures to assist the animal during the remaining time of the parturition, for example turning the offspring and/or dragging it out of the animal 401; alternatively cal a veterinarian, etc.

The parturition event 200a, 200b is divided into a plurality of parturition stages 210a, 210b, 210c, 210x before the offspring is separated from the animal 401, such as two, three, four, five, etc.

A first parturition stage 210a of the plurality of parturition stages 210a, 210b, 210c, 210x of the parturition event 200a, 200b may comprise detection of an amniotic sac leaving the animal 401 in an image.

A second parturition stage 210b of the plurality of parturition stages 210a, 210b, 210c, 210x of the parturition event 200a, 200b may comprise detection of at least one frontal hoof and/or head of the offspring leaving the animal 401 in an image.

A third parturition stage 210c of the plurality of parturition stages 210a, 210b, 210c, 210x of the parturition event 200a, 200b may comprise detection of at least 50% of the offspring leaving the animal 401 in an image.

The system 400 comprises a control model 120, trained by the processing device 110 according to any one of the embodiments of FIGS. 1-3 and discussed in association with the corresponding sections of the description. The control model 120 is trained to detect at least one parturition stage 210a, 210b, 210c, 210x out of a plurality of parturition stages 210a, 210b, 210c, 210x wherein said training is based on images of several parturition stages 210a, 210b, 210c, 210x during a multitude of parturition events 200a, 200b.

The control model 120 may be embodied as an artificial neural network comprising an input layer 310, at least one hidden layer 320 and an output layer 330.

The control model 120 is configured to repeatedly receive images via a controller 410, detect the parturition stage 210a, 210b, 210c, 210x of the received images and return information concerning the detected parturition stage 210a, 210b, 210c, 210x of the images, to the controller 410, also comprised in the system 400.

The system 400 also comprises a camera 420 configured to capture a time-sequential stream of images of the animal 401 and provide the time-sequential stream of images to the control model 120, via the controller 410.

The control model 120, when provided with images, may detect one selected parturition stage 210a, 210b, 210c, 210x out of the plurality of parturition stages 210a, 210b, 210c, 210x by using an object detection algorithm, such as for example YOLO, Faster R-CNN, SSD, etc.

The camera 420 may be a video camera, directed in order to capture images of the pregnant animal 401. Each image may comprise a time stamp. The camera 420 may be embodied as stereo cameras, a 3D camera, a lidar and/or a thermal camera, or similar device, configured to capture a time-sequential stream of images of the animal 401 and provide the time-sequential stream of images to the control model 120, via the controller 410.

Additionally, the system 400 comprises an alerting device 430, configured to output an alerting signal when receiving a trigger signal from the controller 410. The alerting device 430 may be embodied as a communication device of the farmer such as e.g., a mobile device, wireless terminal, mobile telephone, cellular telephone, etc.; a computer, an augmented re-ality device; a pair of intelligent glasses or lenses; an intelligent watch or other wearable communication devices, etc.; and the alerting signal may be output as an audible signal, a visual text, an image and/or light, and/or a haptic signal.

Alternatively, or additionally, the alerting device 430 may be a one-way communication device, i.e., enabling communication from the controller 410 to the farmer, such as a loud-speaker, a light emitting device, etc.

The controller 410 of the system 400 may be referred to as a computer or similar arrange-ment having computational and communicational capacity. The controller 410 is communicatively connected with the camera 420, the control model 120 and the alerting device 430, via a wired and/or wireless communication connection. The controller 410 is configured to provide the time-sequential stream of images captured by the camera 420, to the control model 120.

One parturition stage 210a, 210b, 210c, 210x out of the plurality of parturition stages 210a, 210b, 210c, 210x may be selected, for example a first parturition stage 210a comprising detection of at least one frontal hoof and/or head of the offspring leaving the animal 401; a second parturition stage 210b, comprising detection of at least one frontal hoof and/or head of the offspring leaving the animal 401; a third parturition stage 210c, comprising detection of at least 50% of the offspring leaving the animal 401.

Also, the controller 410 is configured to determine a moment in time when the selected parturition stage 210a, 210b, 210c, 210x of the parturition event 200a, 200b is commenced, based on the control model 120. The moment in time when the selected parturition stage 210a, 210b, 210c, 210x is commenced may be determined either by extracting a time stamp of the image, for which the parturition stage 210a, 210b, 210c, 210x in question is commenced; or by determining the current time by a time measurement functionality; alternatively by starting a timer.

The controller 410 is also configured to determine, repeatedly, by the time measurement functionality, a passed time period since the determined moment in time when the selected parturition stage 210a, 210b, 210c, 210x is commenced.

Additionally, the controller 410 is configured to compare, repeatedly, the determined passed time period since the determined moment in time when the selected parturition stage 210a, 210b, 210c, 210x is commenced with a time threshold length associated with the parturition stage 210a, 210b, 210c, 210x in question. Based there upon, on the outcome of the comparison, the controller 410 is configured to either detect an anomaly of the parturition event 200a, 200b when the time threshold length associated with the selected parturition stage 210a, 210b, 210c, 210x is exceeded by the determined time period that has passed since the determined moment in time when the selected parturition stage 210a, 210b, 210c, 210x is commenced. The controller 410 is also configured to output the trigger signal to the alerting device 430, upon detection of the anomaly.

The controller 410 is also configured to determine when the selected parturition stage 210a, 210b, 210c, 210x of the parturition event 200a, 200b is completed before the time threshold length associated with the selected parturition stage 210a, 210b, 210c, 210x has passed, based on information returned by the control model 120.

By detecting when the selected parturition stage 210a, 210b, 210c, 210x exceeds the associated time threshold length and alerting the farmer, parturition accidents and suffering of the animal 401 and/or the offspring is suppressed.

Thanks to the disclosed invention, death of new-born offsprings and post-parturition problems of the animal 401 is kept low, yet the farmer is relieved from the prior art methodology of manually monitoring every parturition at the farm.

The system 400 may in addition comprise an animal identification device 440, 450 configured to determine an identity reference of the animal 401. The animal identification device 440, may comprise a tag 440 attached to a body part of the animal 401 such as a transponder, a Radio-Frequency Identification (RFID) device or similar wireless tag, and an animal identification reader 450, configured to obtain an identity reference of the animal 401 from the animal identification device/tag/RFID device 440.

The wireless signals may be transmitted between the animal identification device/tag/RFID device 440 and the animal identification reader 450 via any convenient wireless communication technology such as Ultra-Wide Band (UWB), Bluetooth (BT), Wireless Universal Serial Bus (Wireless USB), Radio-Frequency Identification (RFID), Wi-Fi, etc.

The animal identification device/tag/RFID device 440 may comprise information which is uniquely identifying the animal 401, i.e., an identity reference such as a locally or globally unique number, name, and/or code, etc.

In other embodiments, the animal identification device 440, 450 may comprise a camera and a processor, configured to capture an image of the animal 401 and identify the animal 401 based on the pattern of markings in the animal skin, as recognised on the captured animal image and determined by the processor in cooperation with an image recognition program, comparing the captured image with previously captured images of animals at the farm. A comparison may be made with a register over pre-stored patterns of animals in the herd. In yet some further embodiments, the animal identification device 440, 450 may comprise an identity code such as a bar code European Article Number (EAN) code, data matrix, Quick Response (QR) code or other graphic encoding which may be tattooed or painted on the animal skin, which may be read by a code reader 450.

Also, the system 400 also comprises a database 460 comprising a lactation number associated with identity references of the animals 401. The database 460 may be situated at the farm in some embodiments. Alternatively, the database 460 may be situated remotely from the farm and be accessible via a wired or wireless communication interface.

In some embodiments, the database 460 may comprise other information related to the identity references of the animals 401, such as previously experienced parturition problems of the animal 401, which may influence the setting of the time threshold length associated with the parturition stages 210a, 210b, 210c, 210x of the animal 401.

The time threshold length associated with the respective parturition stage 210a, 210b, 210c, 210x of the animal 401 may in some embodiments be adjusted taking the animal breed of the animal 401 into regard, as different breeds may have different body constitution and therefore different tendencies to have problems during parturition, or problems of different types. Animal breed of the animal 401 may be stored and maintained in the database 460.

In some embodiments, the controller 410 may be configured to obtain the identity reference of the animal 401, from the animal identification device 440, 450. The controller 410 may also be configured to provide the identity reference of the animal 401 to the database 460. Also, the controller 410 may be configured to receive the lactation number of the animal 401 from the database 460. Based on the received lactation number, the controller 410 may then set the time threshold length associated with the selected parturition stage 210a, 210b, 210c, 210x of the animal 401.

In yet some embodiments, the system 400 additionally may comprise an animal-attached sensor 440, such as a 3-Dimensional (3D) accelerometer, an inertia sensor, a gyro sensor, a pedometer, a heartbeat sensor, a blood pressure monitoring device and/or a thermal sensor, when the control model 120 has been trained with measurements of a physical parameter, made by the same or corresponding sensor type as the animal-attached sensor 440, to detect at least one parturition stage 210a, 210b, 210c, 210x out of the plurality of parturition stages 210a, 210b, 210c, 210x, based on physical parameter measurements obtained during several parturition stages 210a, 210b, 210c, 210x of the multitude of parturition events 200a, 200b.

The sensor 440 may be configured to measure the physical parameter related to the animal 401, such as body temperature, movement directions, movement speed/acceleration, heartbeat rhythm, etc., possibly associated with a time stamp. The sensor 440 may repeatedly measure and provide the physical parameter of the animal 401 to the control model 120, via the controller 410.

The control model 120 may be configured to repeatedly receive the physical parameter measurements via the controller 410, detect the parturition stage 210a, 210b, 210c, 210x of the received physical parameter measurements and return information concerning the detected parturition stage 210a, 210b, 210c, 210x of the physical parameter measurements, to the controller 410.

The controller 410 may also be configured to provide physical parameter measurements made by the animal-attached sensor 440 to the control model 120.

The controller 410 may also be configured to determine that a dystocia stage 210x of the plurality of parturition stages 210a, 210b, 210c, 210x of the parturition event 200a, 200b is occurring, based on the control model 120. The controller 410 may also be configured to output the trigger signal to the alerting device 430 upon detection of the dystocia stage 210x.

The dystocia stage 210x may be defined by appearance of at least one rear hoof leaving the animal 401, without detection of a front part of the offspring; a back part of the offspring leaving the animal 401, without detection of the front part of the offspring; a head of the offspring leaving the animal 401, without detection of frontal hoofs; or body parts of more than one offspring leaving the animal 401.

The controller 410 may be configured to determine that the parturition event 200a, 200b of the animal 401 has resulted in a successful parturition of the offspring. The controller 410 may also be configured to update the lactation number associated with identity reference of the animal 401 in the database 460 by one.

The controller 410 may comprise a receiver configured to receive signals over a wired or wireless communication interface from the camera 420, the control model 120, the animal identification device 440, 450, the database 460, and/or the animal-attached sensor 440.

The controller 410 may also comprise a processor configured for performing various calcu-lations for conducting the monitoring and detection of the anomaly during the parturition event 200a, 200b of the animal 401. Such processor may comprise one or more instances of a processing circuit, i.e., a Central Processing Unit (CPU), a processing unit, a processing circuit, a processor, an Application Specific Integrated Circuit (ASIC), a microprocessor, or other processing logic that may interpret and execute instructions. The herein utilised expression “processor” may thus represent a processing circuitry comprising a plurality of processing circuits, such as, e.g., any, some or all of the ones enumerated above.

Furthermore, the controller 410 may also comprise a memory in some embodiments. The optional memory may comprise a physical device utilised to store data or programs, i.e., sequences of instructions, on a temporary or permanent basis. According to some embodiments, the memory may comprise integrated circuits comprising silicon-based transistors. The memory may comprise e.g., a memory card, a flash memory, a USB memory, a hard disc, or another similar volatile or non-volatile storage unit for storing data such as e.g., ROM (Read-Only Memory), PROM (Programmable Read-Only Memory), EPROM (Erasable PROM), EEPROM (Electrically Erasable PROM), etc. in different embodiments.

Further, the controller 410 may comprise a signal transmitter. The signal transmitter may be configured for transmitting signals via a wired or wireless communication interface to the control model 120, the alerting device 430 and/or the database 240.

The above-described monitoring and detection of the anomaly during the parturition event 200a, 200b of the animal 401 to be performed in the system 400 may be implemented through the one or more processors within the controller 410, together with a computer program for performing at least some of the herein described functions. Thus, the computer program comprises instructions which, when the computer program is executed by the controller 410, cause the controller 410 to carry out the monitoring and detection of the anomaly during the parturition event 200a, 200b of the animal 401 by the control model 120.

The computer program mentioned above may be provided for instance in the form of a com-puter-readable medium, i.e., a data carrier carrying computer program code for performing at least some method steps according to some embodiments when being loaded into the one or more processor of the controller 410. The data carrier may be, e.g., a hard disk, a CD ROM disc, a memory stick, an optical storage device, a magnetic storage device or any other appropriate medium such as a disk or tape that may hold machine readable data in a non-transitory manner. The computer program may furthermore be provided as computer program code on a server and downloaded to the controller 410 remotely, e.g., over an Internet or an intranet connection.

The terminology used in the description of the embodiments as illustrated in the accompanying drawings is not intended to be limiting of the described system 400, control model 120, controller 410, processing device 110, computer program and/or computer-readable medium. Various changes, substitutions and/or alterations may be made, without departing from invention embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, ac-tions, integers, steps, operations, elements, and/or components, but do not preclude the presence or addition of one or more other features, actions, integers, steps, operations, ele-ments, components, and/or groups thereof. A single unit such as e.g., a processor may fulfil the functions of several items recited in the claims. The mere fact that certain measures or features are recited in mutually different dependent claims, illustrated in different figures or discussed in conjunction with different embodiments does not indicate that a combination of these measures or features cannot be used to advantage. A computer program may be stored/distributed on a suitable medium, such as an optical storage medium or a solid-state medium supplied together with or as part of other hardware but may also be distributed in other forms such as via Internet or other wired or wireless communication system.

1. A system for alerting a farmer when an anomaly is detected during a parturition event before an offspring is separated from an animal, wherein the system comprises:
a control model trained to detect at least one parturition stage out of a plurality of parturition stages wherein said training is based on images of the plurality of parturition stages during a multitude of parturition events; and wherein the control model is configured to repeatedly receive images via a controller, detect the parturition stage of the received image and return information concerning the detected parturition stage of the image, to the controller;
a camera configured to capture a time-sequential stream of images of the animal and provide the time-sequential stream of images to the control model, via the controller;
an alerting device, configured to output an alerting signal when receiving a trigger signal from the controller;
the controller, communicatively connected to the control model, to the camera and the alerting device, wherein the controller is configured to
provide the time-sequential stream of images, captured by the camera, to the control model;
determine a moment in time when a selected parturition stage of the plurality of parturition stages of the parturition event is commenced, based on information returned by the control model;
determine, repeatedly, by a time measurement functionality, a passed time period since the determined moment in time when the selected parturition stage is commenced;
compare, repeatedly, the determined passed time period since the determined moment in time when the selected parturition stage is commenced, with a time threshold length associated with the selected parturition stage; and
either
detect an anomaly of the parturition event when the time threshold length associated with the selected parturition stage is exceeded by the determined time period that has passed since the determined moment in time when the selected parturition stage is commenced; and
output the trigger signal to the alerting device, upon detection of the anomaly; or
determine when the selected parturition stage of the parturition event is completed before the time threshold length associated with the selected parturition stage has passed, based on information returned by the control model.

2. The system according to claim 1, comprising:
an animal identification device configured to determine an identity reference of the animal;
a database comprising a lactation number associated with identity references of the animals;
wherein the controller is configured to
obtain the identity reference of the animal;
provide the identity reference of the animal to the database;
receive the lactation number of the animal from the database; and
set the time threshold length associated with the selected parturition stage of the animal, based on the received lactation number.

3. The system according to claim 1, wherein the camera comprises:
a video camera, stereo cameras, a three dimensional, 3D, camera, and/or a thermal camera, configured to capture the time-sequential stream of images of the animal.

4. The system according to claim 1, wherein the control model is trained to detect at least one parturition stage out of the plurality of parturition stages, wherein said training is based on measurements of a physical parameter of animals during the plurality of parturition stages during a multitude of parturition events; and
wherein the control model is configured to repeatedly receive physical parameter measurements of the animal via the controller, detect the parturition stage of the received physical parameter measurements and return information concerning the detected parturition stage of the physical parameter measurements, to the controller;
and wherein the system comprises:
an animal-attached sensor such as a 3D accelerometer, an inertia sensor, a gyro sensor, a heartbeat sensor and/or a thermal sensor, configured to measure a physical parameter related to the animal; and
wherein the controller is communicatively connected to the animal-attached sensor; and wherein the controller is configured to
obtain the measured physical parameter related to the animal from the animal-attached sensor; and
provide the obtained physical parameter measurement related to the animal to the control model; and
wherein the information returned by the control model is based on the physical parameter measurement.

5. The system according to claim 1, wherein
the selected parturition stage of the plurality of parturition stages of the parturition event comprises detection of an amniotic sac leaving the animal in an image.

6. The system according to claim 1, wherein
the selected parturition stage of the plurality of parturition stages of the parturition event comprises detection of at least one frontal hoof and/or head of the offspring leaving the animal in an image.

7. The system according to claim 1, wherein
the selected parturition stage of the plurality of parturition stages of the parturition event comprises detection of at least 50% of the offspring leaving the animal in an image.

8. The system according to claim 1, wherein
the selected parturition stage of the plurality of parturition stages of the parturition event comprises detection of a dystocia stage in an image;
and wherein the controller is configured to detect the anomaly of the parturition event when the selected parturition stage comprises the dystocia stage; and
output the trigger signal to the alerting device, upon detection of the anomaly.

9. The system according to claim 8, wherein the dystocia stage is defined by appearance of:
at least one rear hoof leaving the animal, without detection of a front part of the offspring;
a back part of the offspring leaving the animal, without detection of the front part of the offspring;
a head of the offspring leaving the animal, without detection of frontal hoofs; or
body parts of more than one offspring leaving the animal.

10. The system according to claim 2, wherein the controller is configured to:
determine that the parturition event of the animal has resulted in a successful parturition of the offspring; and
update the lactation number associated with identity reference of the animal in the database by one.

11. The system according to claim 1, wherein the control model is embodied as an artificial neural network comprising an input layer, at least one hidden layer and an output layer.

12. The system according to claim 1 wherein the plurality of parturition stages comprise: detection of an amniotic sac leaving the animal; detection of at least one frontal hoof and/or head of the offspring leaving the animal; detection of at least 50% of the offspring leaving the animal; and detection of a dystocia stage.

13. The system according to claim 1 wherein the images of the plurality of parturition stages on which the training is based are annotated with bounding boxes across a feature representing the parturition stage within each image.

14. A system for alerting a farmer when an anomaly is detected during a parturition event before an offspring is separated from an animal, wherein the system comprises:
a control model trained to detect at least one parturition stage out of a plurality of parturition stages wherein said training is based on images of several parturition stages during a multitude of parturition events; and wherein the control model is configured to repeatedly receive images via a controller, detect the parturition stage of the received image and return information concerning the detected parturition stage of the image, to the controller;
a first camera comprising a thermal camera and a second camera selected from the group consisting of a video camera, stereo cameras, and a three dimensional (3D) camera, wherein the first camera and the second camera are each configured to capture a time-sequential stream of images of the animal and provide the time-sequential streams of images to the control model, via the controller;
wherein the images of several parturition states on which the control module was trained comprise thermal images and non-thermal images;
wherein the system is configured to detect an amniotic sac leaving the animal in a thermal image from the thermal camera,
wherein the system is configured to detect in a non-thermal image from the second camera
at least one rear hoof leaving the animal, without detection of a front part of the offspring;
a back part of the offspring leaving the animal, without detection of the front part of the offspring;
a head of the offspring leaving the animal, without detection of frontal hoofs; or
body parts of more than one offspring leaving the animal;
an alerting device configured to output an alerting signal when receiving a trigger signal from the controller;
the controller communicatively connected to the control model, to the camera, and to the alerting device, wherein the controller is configured to
provide the time-sequential stream of images, captured by the camera, to the control model;
determine a moment in time when a selected parturition stage of the at least one parturition stages of the parturition event is commenced, based on information returned by the control model;
determine, repeatedly, by a time measurement functionality, a passed time period since the determined moment in time when the selected parturition stage is commenced;
compare, repeatedly, the determined passed time period since the determined moment in time when the selected parturition stage is commenced, with a time threshold length associated with the selected parturition stage; and
either
detect an anomaly of the parturition event when the time threshold length associated with the selected parturition stage is exceeded by the determined time period that has passed since the determined moment in time when the selected parturition stage is commenced; and
output the trigger signal to the alerting device, upon detection of the anomaly;
or
determine when the selected parturition stage of the parturition event is completed before the time threshold length associated with the selected parturition stage has passed, based on information returned by the control model.

15. The system according to claim 14, wherein the selected parturition stage of the plurality of parturition stages of the parturition event comprises detection of a dystocia stage in an image; and wherein the controller is configured to:
detect the anomaly of the parturition event when the selected parturition stage comprises the dystocia stage; and
output the trigger signal to the alerting device, upon detection of the anomaly.

16. The system according to claim 15, wherein the dystocia stage is defined by appearance of:
at least one rear hoof leaving the animal, without detection of a front part of the offspring;
a back part of the offspring leaving the animal, without detection of the front part of the offspring;
a head of the offspring leaving the animal, without detection of frontal hoofs; or
body parts of more than one offspring leaving the animal.

17. The system according to claim 14 further comprising:
an animal identification device configured to determine an identity reference of the animal;
a database comprising a lactation number associated with identity references of the animals;
wherein the controller is configured to
obtain the identity reference of the animal;
provide the identity reference of the animal to the database;
receive the lactation number of the animal from the database; and
set the time threshold length associated with the selected parturition stage of the animal, based on the received lactation number.

18. The system according to claim 14, wherein the selected parturition stage of the plurality of parturition stages of the parturition event comprises detection of at least 50% of the offspring leaving the animal in an image.

19. The system according to claim 14, wherein the control model is embodied as an artificial neural network comprising an input layer, at least one hidden layer, and an output layer.
